(19) United States
(12) Patent Application Publication
(10) Pub. No.: US 2025/0104955 A1
(43) Pub. Date: Mar. 27, 2025

(54) Hard Anodized Aluminum Housing for Electric Fuses

(71) Applicant: Eaton Intelligent Power Limited, Dublin (IE)

(72) Inventor: Robert Stephen Douglass, Wildwood, MO (US)

(21) Appl. No.: 18/896,463

(22) Filed: Sep. 25, 2024

Related U.S. Application Data
(60) Provisional application No. 63/584,989, filed on Sep. 25, 2023.

(51) Int. Cl. H01H 85/175; H01H 69/02; H01H 85/17; H01H 85/42

(52) U.S. Cl. CPC H01H 85/175; H01H 85/17; H01H 85/42; H01H 69/02

(57) ABSTRACT

In an embodiment, an electric fuse housing comprises one or more electrical insulating plates and an anodized metal can structure, where the anodized metal can structure comprises a metal layer, a barrier layer, and an oxide layer. The barrier layer and the oxide layer are formed on top of the metal layer using a hard anodizing process. The oxide layer includes a plurality of pores that is filled with one or more substances.

### PRIORITY

This application claims the benefit under 35 U.S.C. § 119(e) of U.S. Provisional Patent Application No. 63/584,989, filed 25 Sep. 2023, which is incorporated herein by reference.

### TECHNICAL FIELD

The field of the invention relates generally to housing for electric fuses, and more specifically to a hard anodized housing for electric fuses.

### BACKGROUND

Fuses are widely used as overcurrent protection devices to prevent costly damage to components within electrical circuits. In an electrical circuit, fuses are typically configured between a power source and electrical components. When a circuit experiences overcurrent, fuses are configured to melt and open, effectively disconnecting the rest of the electrical components from the power source and preventing the electrical components from being damaged. After a fuse melts, an electrical arc occurs. An arc flash from the electrical arc may be an explosive release of energy that produces significant heat and/or explosion. An electric fuse housing is required to protect the surrounding electrical components from the arc.

Fuses and internal fusible filaments have been manufactured for the past century using a variety of materials to assure safe and reliable operations during an interruption process. Early fuse housings were fabricated from wood in the form of boxes and later of pulp fiber. Cylindrical tube quickly became the standard shape for the fuse, and fuses made in such shape were commonly known as cartridge fuses. Throughout the years, fuses made from paper fiber material were enhanced, strengthened, and made more heat resistant with additives of earth clay, gypsum, plaster of Paris and paste adhesives. Further enhancements were also made using the vulcanization process and introduction of zinc chloride. Fuses made from vulcanized fiber are still popular today and used for electrical insulating applications. Fuses are also commonly made from other materials, including composite tubes of glass-melamine, glass-epoxy or tubes of various ceramic or glass compounds.

Fuse housings made from polymetric resins are relatively new. Fuse housings made with thermoset polyester resins can be shaped into various shapes beyond the typical cylindrical tubes, for example, by using compression molding techniques. Pultrusion tube forming processes may also be used to produce glass reinforced thermoset fuse tubes in long continuous lengths. However, while fuses made with polymer materials can be molded into various shapes, their mechanical strengths and thermal resistance properties are relatively weak. And thus, traditional fuses made from polymer materials are not well suited for some of the fuse operating conditions that are common today, e.g., temporary temperatures as high as 500° C. and arc pressurization impulses as high as 50×105 Pa. And thus, there is a need for a new type of fuse that is flexible enough to be shaped for various fuse operations while offering superior strength and thermal resistance properties beyond what is offered today.

### BRIEF DESCRIPTION OF THE DRAWINGS

Embodiments in accordance with this disclosure will now be described by reference to the accompanying drawings, in which:

FIG. 1 illustrates an example of an anodizing process.

FIGS. 2A, 2B, 2C, and 2D illustrate an example of an anodizing process.

FIG. 3A illustrates an isometric view of an example aluminum that is hard anodized.

FIG. 3B illustrates a cross-section view of an example aluminum that is hard anodized.

FIG. 4A illustrates an example of an axial fuse type.

FIG. 4B illustrates a perspective view of an example axial fuse type.

FIG. 5 illustrates a cross-section view of an example axial fuse type with hard anodized aluminum fuse housing.

FIG. 6A illustrates an example of a radial fuse type.

FIG. 6B illustrates a perspective view of an example radial fuse type.

FIG. 7 illustrates a cross-section view of an example radial fuse type with hard anodized aluminum fuse housing.

### SUMMARY OF PARTICULAR EMBODIMENTS

Particular embodiments described herein relate to electrically and thermally insulated fuse housings that are strong enough to protect the surrounding electrical components from an explosion caused by an arc. After a fuse melts, an electrical arc occurs. An arc flash from the electrical arc may be an explosive release of energy that produces significant heat and/or explosion. An electric fuse housing is required to protect the surrounding electrical components of a circuit from the arc. Also, the demands for smaller fuses are growing, which require better thermal and pressure protection on the fuse housings.

In particular embodiments, an electric fuse housing may comprise an anodized metal can structure and one or more electrical insulating plates. In particular embodiments, the electrical fuse housing is filled with filler. The anodized metal can structure may comprise a metal layer, a barrier layer, and an oxide layer. In particular embodiments, the metal layer may be comprised of aluminum. The barrier layer and the oxide layer may be formed on top of the metal layer using a hard anodizing process. The oxide layer may comprise a plurality of pores. The plurality of pores may be filled with one or more substances. In particular embodiments, the one or more substances may be applied as conformal coating. To apply conformal coating onto the oxide layer, a liquid solution comprising the one or more substances may be created. The liquid solution may be poured into the plurality of pores. In particular embodiments, an anodized metal can structure may be put into a pool of the liquid solution. In particular embodiments, applying conformal coating may further comprise applying one or more techniques to reduce surface tension. The one or more techniques to reduce surface tension may comprise ultrasonic, vacuum pressurization, oscillation, or heating. In particular embodiments, carrier of the liquid solution may comprise solvent or alcohol.

In particular embodiments, the one or more substances may comprise a color dye. In particular embodiments, the one or more substances may comprise an electrical or thermal insulating substance. The electrical or thermal insulating substance may comprise silicon rubber or ceramic. In particular embodiments, the insulating substance may be both electrical insulating and thermal insulating substance. In particular embodiments, the one or more substances may comprise an arc interruption substance. The arc interruption substance may release one or more elements when an electric arc occurs within the electric fuse housing to cool heat caused by the electric arc. In particular embodiments, the one or more elements comprise hydrogen, nitrogen, or oxygen.

In particular embodiments, the barrier layer and the oxide layer may be formed on both sides of the metal layer. In particular embodiments, the plurality of pores on a first oxide layer on a first side of the metal layer may be filled by one or more first substances. In particular embodiments, the plurality of pores on a second oxide layer on a second side of the metal layer may be filled by one or more second substances. The one or more first substances may be identical to, or alternatively different than, the one or more second substances.

In particular embodiments, the one or more electrical insulating plates are assembled with the anodized metal can structure to make the electrical fuse housing sealed. In particular embodiments, the one or more electrical insulating plates may be made of polymer, ceramic, or anodized metal. In particular embodiments, a portion of the anodized metal can structure may be secured to the one or more electrical insulating plates by a way of crimping the portion of the anodized metal can structure. In particular embodiments, a portion of the anodized metal can structure may be secured to the one or more electrical insulating plates by applying adhesive between the one or more electrical insulating plates and the portion of anodized metal can structure. In particular embodiments, a portion of the anodized metal can structure may be secured to the one or more electrical insulating plates by a way of crimping the portion of the anodized metal can structure and by applying adhesive between the one or more electrical insulating plates and the portion of anodized metal can structure. assembling the anodized metal can structure with the one or more electrical insulating plates may comprise crimping the anodized metal can structure onto the one or more electrical insulating plates. In particular embodiments, assembling the anodized metal can structure with the one or more electrical insulating plates may comprise applying adhesive between the one or more electrical insulating plates and the anodized metal can structure. In particular embodiments, assembling the anodized metal can structure with the one or more electrical insulating plates may comprise both crimping the anodized metal can structure onto the one or more electrical insulating plates and applying adhesive between the one or more electrical insulating plates and the anodized metal can structure.

In particular embodiments, the electric fuse housing may be configured as an axial fuse. In particular embodiments, the electric fuse housing may be configured as a radial fuse.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### DESCRIPTION OF EXAMPLE EMBODIMENTS

In particular embodiments, an electric fuse housing may comprise an anodized metal can structure and one or more electrical insulating plates. The anodized metal can structure may comprise a metal layer, a barrier layer, and an oxide layer. In particular embodiments, the metal layer may be comprised of aluminum. In particular embodiments, the metal layer may be comprised of any metal other than aluminum. The barrier layer and the oxide layer may be formed on top of the metal layer using a hard anodizing process.

In particular embodiments, a metal can structure used for an electric fuse housing may be anodized. Hard anodizing, also referred to as hard-coat anodizing, is a technique used to give a material a stronger surface to better resist wear and abrasion. By immersing, for example, aluminum into sulfuric acid and passing an electric current through the acid solution, a thin coating of aluminum oxide or anodic aluminum oxide (AAO) may form. This process is generally known as anodizing. A related technique referred to as hard anodizing involves creating a much thicker oxide coat by significantly lowering the sulfuric acid solution temperature and greatly increasing the electric current.

The process of anodizing an aluminum can be characterized by three commonly accepted types. Type I anodizing utilizes chromic acid to produce an oxide thickness of 20-100 microinches. Type II anodizing utilizes sulfuric acid to produce oxide thicknesses from 100-1000 microinches. Type III anodizing, also known as hard anodizing, utilizes stronger sulfuric acid applied at reduced temperatures and subjected to higher electrical currents to produce oxide thicknesses up to 0.006 inches.

Hard-coat anodizing creates a unique structure of dense oxide layer comprising porous hexagonal tubes. These porous structures can be utilized to capture and adhere various materials such as dyes, sealants, and other coatings to enhance the appearance and properties of the finished anodized part. The thick layer of aluminum oxide formed on the aluminum surface can be extremely heat resistant and may be able to withstand short exposures of up to 2000° C. The oxide layer may also have electrically insulated properties, e.g., dielectric withstand properties of 800 volts per mil (0.001″).

Aluminum can be formed or machined into various shapes used for a fuse enclosure or housing. Aluminum in melted liquid form can be cast or molded using a casting or molding die to produce unique shapes for fuse enclosures and housings. Once the fuse housing has been fabricated, the exposed surfaces of the aluminum can be anodized.

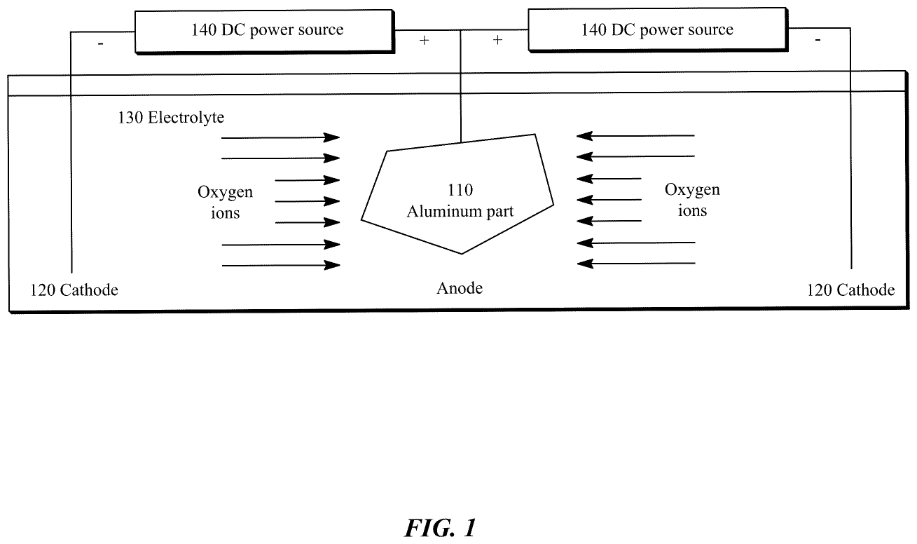

FIG. 1 illustrates an anodizing process that uses electrolysis to grow a metal oxide layer on the surface of a metal. Aluminum 110 may be a common metal that uses the anodizing process to form the oxide layer or coating. This disclosure contemplates various other metals beyond just aluminum. In particular embodiments, an oxide layer may be formed on the exposed surfaces of aluminum by using sulfuric acid as the electrolyte 130. When current from a direct current (DC) power source 1400 is applied to the electrolyte 130 solution in which the aluminum 110 is submersed, hydrogen may be released at the cathode 120 and oxygen at the surface of the aluminum 110, creating a build-up of aluminum oxide.

Electrochemistry for the anodizing process may the following.
electrochemical reaction at the anode:

2AL+3H₂O=AL₂O₃+6H⁺+6e⁻; (1)
electrochemical reaction at the cathode:

6H⁺+6e⁻=3H₂; (2)
resulting anodizing reaction:

2AL+3H₂O=AL₂O₃+3H₂; and (3)
aluminum oxide may form several hydrates:

AL₂O₃*(H₂O)ₙ[n=1 to3]. (4)

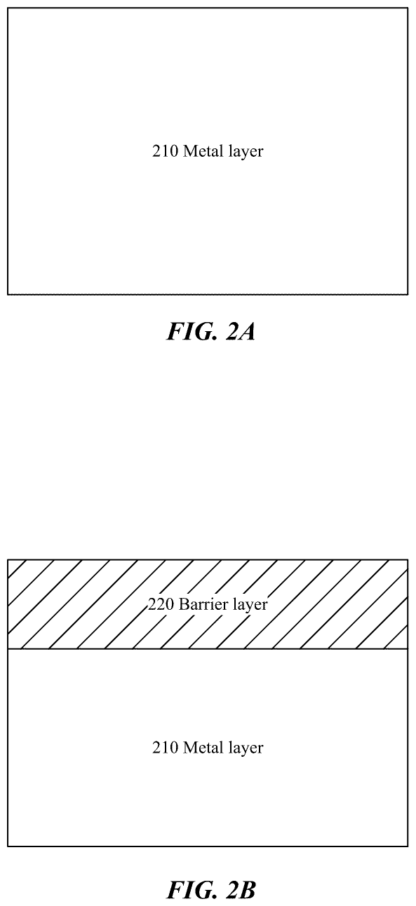

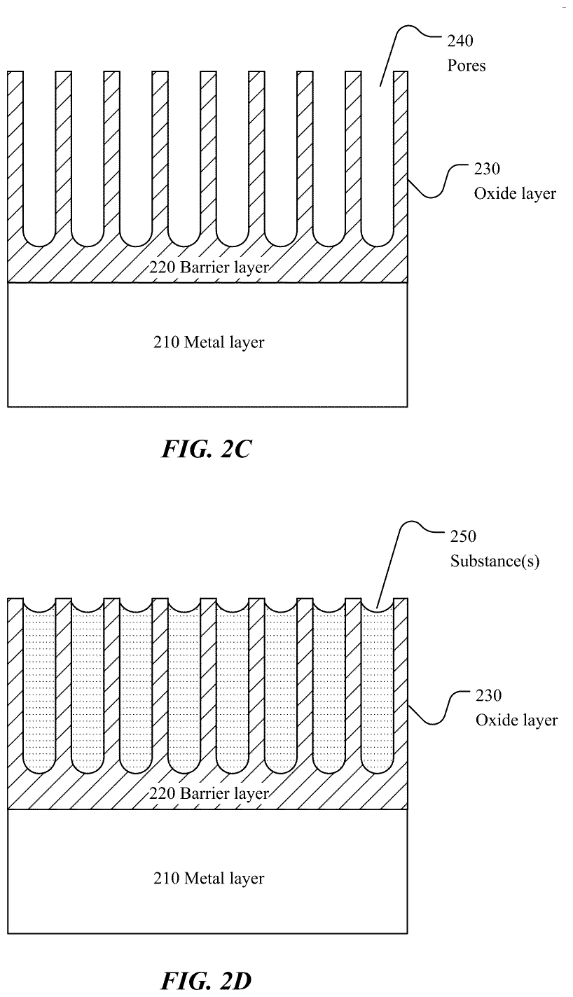

FIGS. 2A, 2B, 2C, and 2D illustrates the progression of an anodizing process. FIG. 2A illustrates a metal 210 (e.g., aluminum) that is to be anodized. FIG. 2B illustrates the first progression of the anodizing process where a barrier layer 220 is formed on the exposed surface of the metal layer 210. The barrier layer 220 can be formed with neutral electrolyte solutions. FIG. 2C illustrates a subsequent progression of the anodizing process where a porous cellular oxide structure is formed on the oxide layer 230. The porous cellular oxide structure may form in acidic electrolyte solutions, in which oxide both grows and is dissolved. Thus, the oxide layer 230 may comprise a plurality of pores 240. FIG. 2D illustrates the last progression of the anodizing process where the plurality of pores is filled with one or more substances 250. The plurality of pores 240 may be filled with one or more substances 250 to provide desirable characteristics to the metal. As an example not by way of limitation, the plurality of pores 240 may be filled with insulating type materials, such as silicon materials. As another example not by way of limitation, the plurality of pores 240 may be filled with color dyes. In particular embodiments, the plurality of pores 240 may be partially filled, fully filled, or filled to the point the filler material overflows from the porous oxide structure, effectively creating another layer on top of the oxide layer. In particular embodiments, an anodized metal can structure used for an electric fuse housing may be made of a hard anodized metal as depicted in FIGS. 2A-2D.

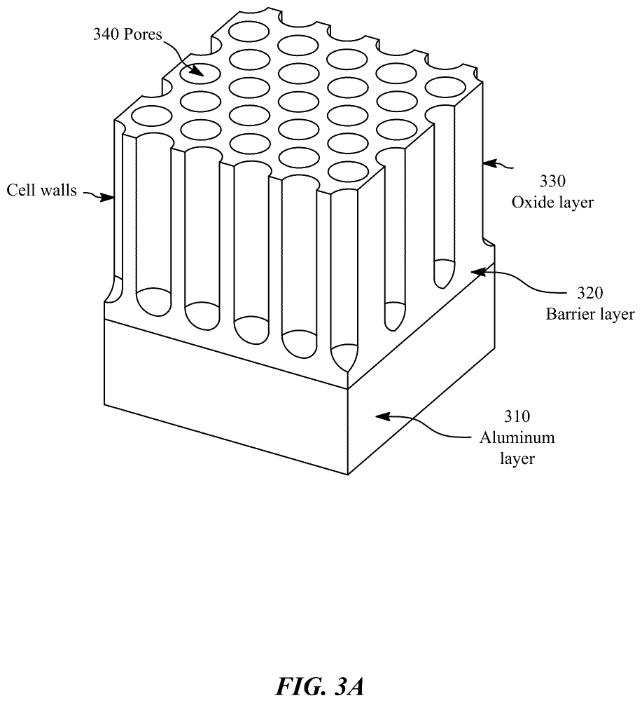

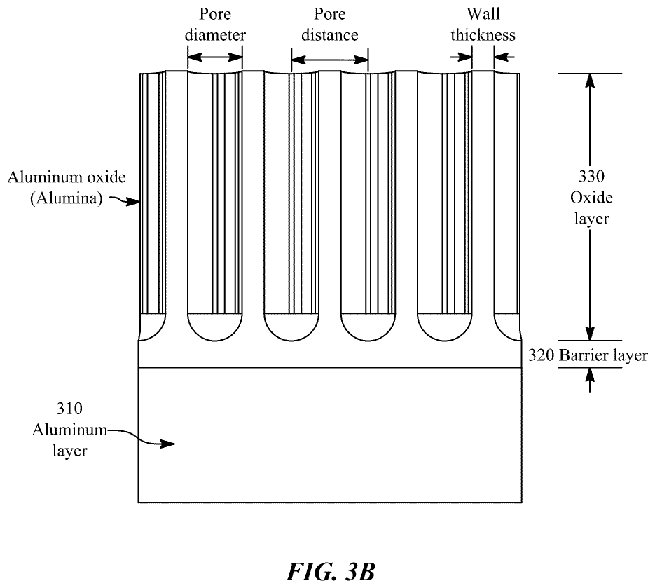

FIG. 3A illustrates an isometric view of an example aluminum that is hard anodized. A barrier layer 320 is built upon an aluminum layer 310. On top of the barrier layer 320, an oxide layer 330 is built. The oxide layer 330 may comprise a plurality of pores 340. FIG. 3B illustrates a cross-section view of an example aluminum that is hard anodized. The hard anodizing process may be used to create an oxide layer 330 on top of a barrier layer 320. The oxide layer 330 may be of aluminum oxide (alumina), which is polymer. The oxide layer 330 corresponds to the cell walls having hexagonally packed pores 340 in a matrix or array structure. The pore diameter, distance between pores, and oxide thicknesses may be varied by regulating the anodizing process parameters, such as the electrolyte acidity and temperature, and the anodizing voltage and time. In particular embodiments, an anodized metal can structure used for an electric fuse housing may be made of hard anodized aluminum as depicted in FIGS. 33A and 3B.

In particular embodiments, the oxide layer 230 of an anodized metal can structure used for an electric fuse housing may comprise a plurality of pores 240. The plurality of pores 240 may be filled with one or more substances 250 to provide desirable characteristics to the anodized metal can structure.

In particular embodiments, the one or more substances may comprise a color dye. As an example not by way of limitation, the plurality of pores 240 may be filled with a color dye to make a color of a surface of the anodized metal can structure used for an electric fuse housing as desired. A laser etching may be applied on top of the color dye filled into the plurality of pores 240 to print symbols or letter. As another example not by way of limitation, the plurality of pores 240 may be filled with one or more other substances for desired characteristics and be covered by one or more color dyes. The one or more color dyes may be used to color the surface of the anodized metal can structure. The one or more other substances may be used for other desired characteristics. For example, the one or more other substances may be used for an electrical or thermal insulating purpose.

In particular embodiments, the one or more substances may comprise an electrical insulating substance. In particular embodiments, the one or more substances may comprise a thermal insulating substance. In particular embodiments, the one or more substances may comprise an electrical and thermal insulating substance. Those insulating substance may comprise silicon rubber or ceramic. As an example not by way of limitation, a plurality of pores 240 of an inside surface of the anodized metal can structure used for an electric fuse housing may be filled with one or more thermal insulating substances, while a plurality of pores 240 of an outside surface of the anodized metal can structure used for the electric fuse housing may be filled with one or more electrical insulating substances. In particular embodiments, the plurality of pores 240 of the outside surface of the anodized metal can structure used for the electric fuse housing may also be filled with one or more color dyes.

In particular embodiments, the one or more substances may comprise an arc interruption substance. The arc interruption substance may release one or more elements when an electric arc occurs within the electric fuse housing to cool heat caused by the electric arc. In particular embodiments, the one or more elements comprise hydrogen, nitrogen, or oxygen. As an example not by way of limitation, a plurality of pores 240 of an inside surface of an anodized metal can structure used for an electric fuse housing may be filled with one or more polymer substances that may release the one or more elements when an arc occurs within the electric fuse housing. The one or more elements may help cooling the arc. In particular embodiments, the one or more polymer substances may include nylon. In particular embodiments, the one or more elements may include hydrogen, nitrogen, or oxygen. As another example embodiments, a plurality of pores 240 of an inside surface of an anodized metal can structure used for an electric fuse housing may be filled with water covered by one or more other substances. When an arc occurs within the electric fuse housing, the water filled within the plurality of pores 240 may help cooling the arc.

In particular embodiments, the one or more substances 250 may be applied as conformal coating. To apply conformal coating onto the oxide layer 230, a liquid solution comprising the one or more substances 250 may be created. The liquid solution may be poured into the plurality of pores 240. In particular embodiments, applying conformal coating may further comprise applying one or more techniques to reduce surface tension. The one or more techniques to reduce surface tension may comprise ultrasonic, vacuum pressurization, oscillation, or heating. In particular embodiments, carrier of the liquid solution may comprise solvent or alcohol. The particle sizes of solvent or alcohol is considerably smaller than the particle size of water. Thus, using solvent or alcohol as carrier of the liquid solution instead of water may be beneficial for the conformal coating process.

In particular embodiments, the barrier layer 220 and the oxide layer 230 may be formed on both sides of the metal layer 210. In particular embodiments, the plurality of pores 240 on a first oxide layer 230 on a first side of the metal layer 210 may be filled by one or more first substances 250. In particular embodiments, the plurality of pores on a second oxide layer on a second side of the metal layer may be filled by one or more second substances. The one or more first substances may be identical to, or alternatively different than, the one or more second substances.

In particular embodiments, the one or more electrical insulating plates are assembled with the anodized metal can structure to make the electrical fuse housing sealed. In particular embodiments, assembling the anodized metal can structure with the one or more electrical insulating plates may comprise crimping the anodized metal can structure onto the one or more electrical insulating plates. In particular embodiments, assembling the anodized metal can structure with the one or more electrical insulating plates may comprise applying adhesive between the one or more electrical insulating plates and the anodized metal can structure. In particular embodiments, assembling the anodized metal can structure with the one or more electrical insulating plates may comprise both crimping the anodized metal can structure onto the one or more electrical insulating plates and applying adhesive between the one or more electrical insulating plates and the anodized metal can structure.

In particular embodiments, the one or more electrical insulating plates may be made of polymer, ceramic, or anodized metal. A fuse terminal may be attached to each of the one or more electrical insulating plates in an electric fuse housing. Thus, the one or more electrical insulating plates may need to be electrically insulated. Also, the one or more electrical insulating plates may need to be capable of keeping the electrical fuse housing sealed when an arc occurs within the electric fuse housing. Considering those requirements for the electrical insulating plates, polymer, ceramic, or anodized metal, such as anodized aluminum may be used for the one or more electrical insulating plates.

In particular embodiments, the electrical fuse housing is filled with filler. In particular embodiments, the filler may be quartz sand that has high thermal conductivity and insulation properties. Quartz sand may have a large contact area with the arc, which is convenient for absorbing arc energy, thus enabling rapid cooling of the arc.

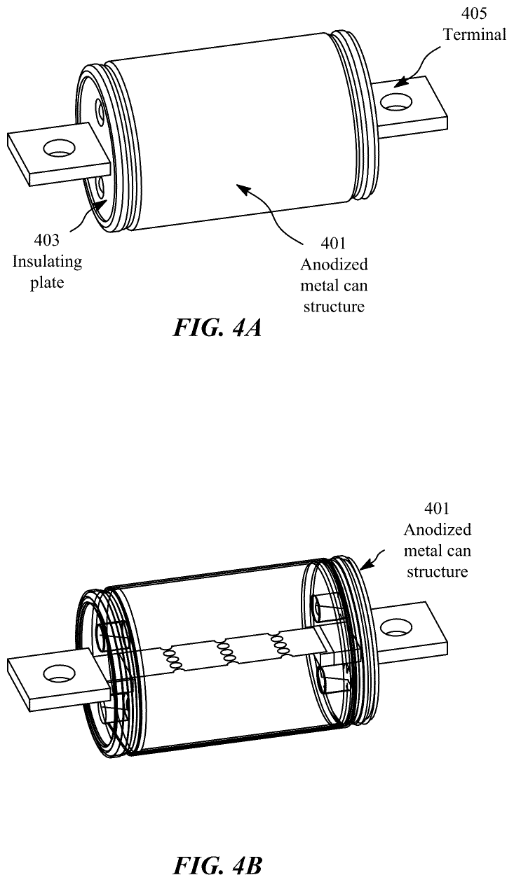

In particular embodiments, the electric fuse housing may be configured as an axial fuse. FIG. 4A illustrates an example of an axial fuse type. FIG. 4B illustrates a perspective view of the axial fuse type. A fuse housing for the axial fuse may comprise a cylindrical anodized metal can structure 401 with insulating plates 403. The axial fuse may comprise a first terminal 405 and a second terminal 405, which may be used to connect the axial fuse to an electronic circuit. Each fuse terminal 405 may extend through an insulating plane 403. The insulating plates 403 may be electrically insulating. The axial fuse may further comprise a fuse element inside the fuse housing.

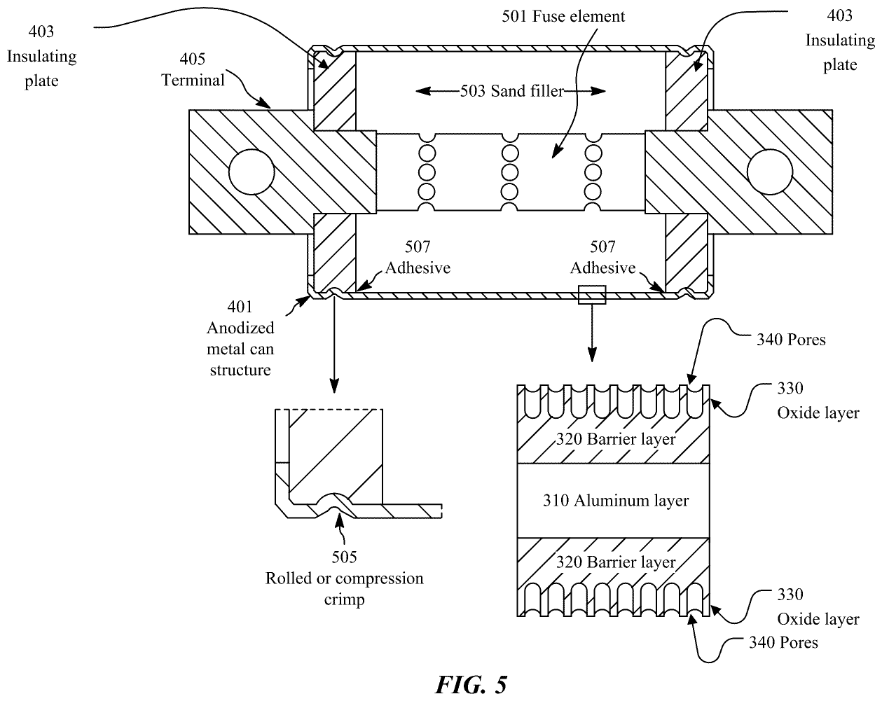

FIG. 5 illustrates a cross-section view of an example axial fuse type with an electric fuse housing. The electric fuse housing for the axial fuse may comprise an anodized metal can structure 401 and two insulating plates 403. The fuse housing may be filled with a sand filler 503 that surrounds a fuse element 501. The sand filler provides thermal insulation and arc quenching properties for the fuse. Each of the fuse terminals 405 may extend from the fuse element 501 through an insulating plate 403. The fuse terminals 405 may connect the axial fuse to an electronic circuit. The insulating plates 403 may be assembled with the anodized metal can structure 401 to make the electrical fuse housing sealed. In particular embodiments, assembling the anodized metal can structure 401 with the insulating plates 403 may comprise crimping the anodized metal can structure 401 onto the insulating plates 403. The crimp 505 may be a rolled crimp or a compression crimp. In particular embodiments, assembling the anodized metal can structure 401 with the insulating plates 403 may comprise applying adhesive 507 between the insulating plates 403 and the anodized metal can structure 401. In particular embodiments, assembling the anodized metal can structure 401 with the insulating plates 403 may comprise both crimping the anodized metal can structure 401 onto the insulating plates 403 and applying adhesive 507 between the insulating plates 403 and the anodized metal can structure 401.

In particular embodiments, the anodized metal can structure 401 may be made from hard anodized aluminum. The barrier layer 320 and the oxide layer 330 may be formed on both sides of the aluminum layer 310 to increase the strength and thermal resistance for both the inner and outer portions of the anodized metal can structure 401. In particular embodiments, the plurality of pores 340 on a first oxide layer 330 on a first side of the aluminum layer 310 may be filled by one or more first substances. The plurality of pores 340 on a second oxide layer 330 on a second side of the aluminum layer 310 may be filled by one or more second substances. The one or more first substances may be identical to, or alternatively different than, the one or more second substances. As an example not by way of limitation, a plurality of pores 340 on the oxide layer 330 of an inside surface of an anodized metal can structure 401 may be filled with electrical and thermal insulating substance, and a plurality of pores 340 on the oxide layer 330 of an outside surface of the anodized metal can structure 401 may be filled with color dyes. In some embodiments, the plurality of pores 340 on the oxide layer 330 of an inside surface may be filled with electrical and thermal insulating substance, and a plurality of pores 340 on the oxide layer 330 of an outside surface of the anodized metal can structure 401 may be filled with environmentally-resistant materials (e.g., materials resistant to corrosion, moisture, and temperature extremes, such as alloys, plastics, ceramics, polymers). In particular embodiments, color dyes may be used in any of the fillers described herein, for example, to indicate the materials used in the fillers or to indicate the electrical rating of the fuse. In particular embodiment, the color dye used in the inside surface may be a different color than the color dye used in the outside surface.

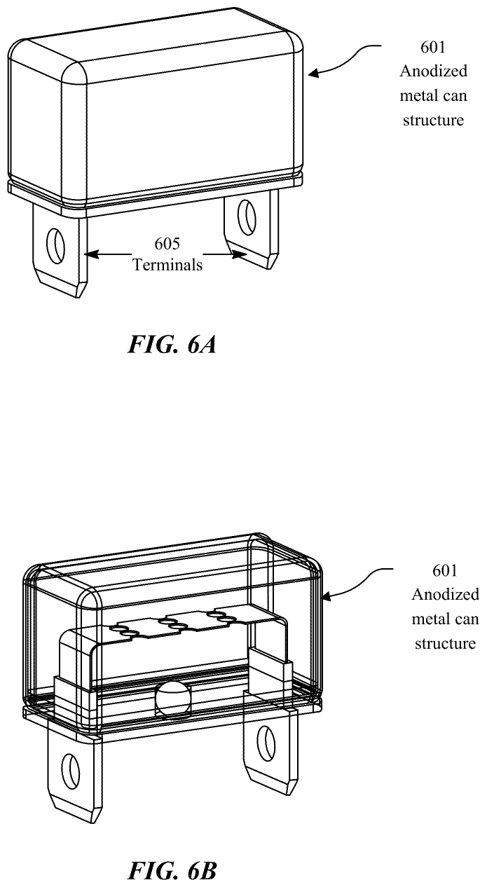

In particular embodiments, the electric fuse housing may be configured as a radial fuse. FIG. 6A illustrates an example of a radial fuse type. FIG. 6B illustrates a perspective view of the radial fuse type. The radial fuse may comprise a top-mounted anodized metal can structure 601 and downward-facing fuse terminals 605 extending through a base insulating plate (not shown in FIGS. 6A and 6B). The radial fuse may be relatively compact compared to other fuse types and may be used in environments with limited space.

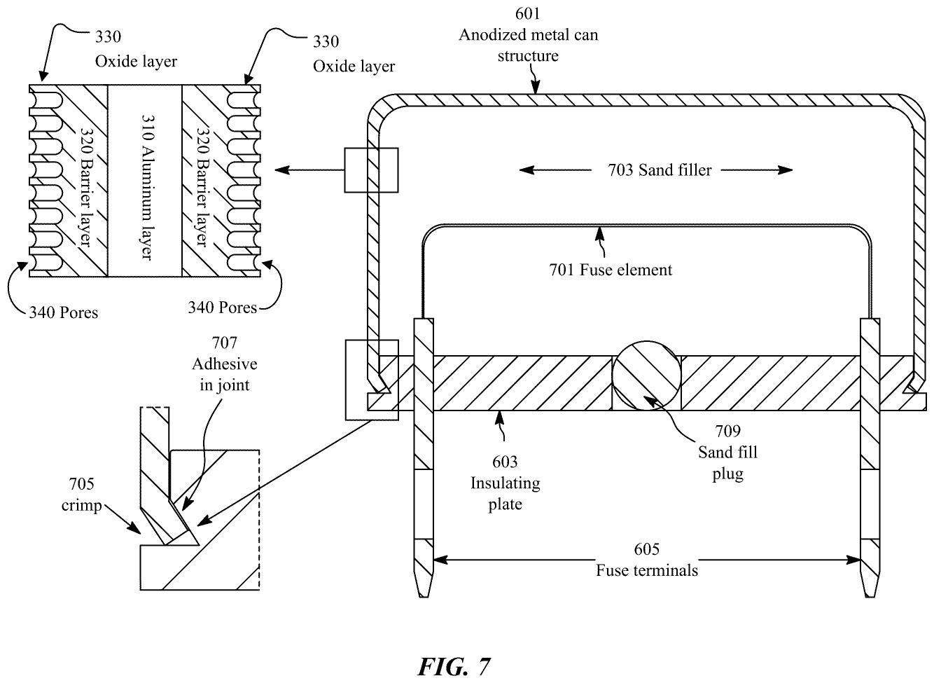

FIG. 7 illustrates a cross-section view of an example radial fuse type with an electric fuse housing. The electric fuse housing may comprise a top-mounted anodized metal can structure 601 and a base insulating plate 603. The electric fuse housing may be filled with a sand filler 703 that surrounds a fuse element 701. The sand filler 703 provides thermal insulation and arc quenching properties for the fuse. The insulating plate 603 may comprise a sand fill plug 709 that may be used for filling the sand filler 703. Both of the fuse terminals 605 may extend from the fuse element 501 through the base insulating plate 603. The fuse terminals 605 may connect the radial fuse to an electronic circuit. The top-mounted anodized metal can structure 601 may be assembled with the insulating plate 603 to make the electrical fuse housing sealed. In particular embodiments, assembling the anodized metal can structure 601 with the insulating plate 603 may comprise crimping the anodized metal can structure 601 onto the insulating plate 603. The crimps 705 may be applied onto both sides of the insulating plate 603. In particular embodiments, assembling the anodized metal can structure 601 with the insulating plates 603 may comprise applying adhesive 707 between the insulating plate 603 and the anodized metal can structure 601. In particular embodiments, assembling the anodized metal can structure 601 with the insulating plate 603 may comprise both crimping the anodized metal can structure 601 onto the insulating plate 603 and applying adhesive 707 between the insulating plates 603 and the anodized metal can structure 601.

In particular embodiments, the anodized metal can structure 601 may be made from hard anodized aluminum. The barrier layer 320 and the oxide layer 330 may be formed on both sides of the aluminum layer 310 to increase the strength and thermal resistance for both the inner and outer portions of the anodized metal can structure 601. In particular embodiments, the plurality of pores 340 on a first oxide layer 330 on a first side of the aluminum layer 310 may be filled by one or more first substances. The plurality of pores 340 on a second oxide layer 330 on a second side of the aluminum layer 310 may be filled by one or more second substances. The one or more first substances may be identical to, or alternatively different than, the one or more second substances. For example, the pores may be filled halfway with a first substance and filled rest of the way with another substance. This allows fuse housing to combine the benefits associated two different substances. In particular embodiments, the plurality of pores 340 may be partially filled, fully filled, or filled to the point the filler substances overflow from the plurality of pores 340, effectively creating another layer on top of the oxide layer 330.

In particular embodiments, the electric fuse housing may be configured as a cylindrical radial fuse. The cylindrical radial fuse may comprise a top-mounted vertically cylindrical shape anodized metal can structure and two downward-facing fuse terminals extending through a circular base insulating plate. Both of the downward-facing fuse terminals may extend from a fuse element through the circular base insulating plate. The fuse terminals may connect the cylindrical radial fuse to an electronic circuit. The top-mounted vertically cylindrical shape anodized metal can structure may be assembled with the circular base insulating plate to make the electrical fuse housing sealed. In particular embodiments, assembling the top-mounted vertically cylindrical shape anodized metal can structure with the circular base insulating plate may comprise crimping the top-mounted vertically cylindrical shape anodized metal can structure onto the circular base insulating plate. In particular embodiments, assembling the top-mounted vertically cylindrical shape anodized metal can structure with the circular base insulating plate may comprise applying adhesive between the circular base insulating plate and the top-mounted vertically cylindrical shape anodized metal can structure. In particular embodiments, assembling the top-mounted vertically cylindrical shape anodized metal can structure with the circular base insulating plate may comprise both crimping the top-mounted vertically cylindrical shape anodized metal can structure onto the circular base insulating plate and applying adhesive between the circular base insulating plates and the top-mounted vertically cylindrical shape anodized metal can structure.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An electric fuse housing comprising:
one or more electrical insulating plates; and
an anodized metal can structure comprising:
a metal layer;
a barrier layer and an oxide layer, wherein the barrier layer and the oxide layer are formed on top of the metal layer using a hard anodizing process, wherein the oxide layer comprises a plurality of pores, and wherein the plurality of pores is filled with one or more substances.

2. The electric fuse housing of claim 1, wherein the one or more substances comprise a color dye.

3. The electric fuse housing of claim 1, wherein the one or more substances comprise an electrical or thermal insulating substance.

4. The electric fuse housing of claim 3, wherein the electrical or thermal insulating substance comprises silicon rubber or ceramic.

5. The electric fuse housing of claim 1, wherein the one or more substances comprise an arc interruption substance.

6. The electric fuse housing of claim 5, wherein the arc interruption substance releases one or more elements when an electric arc occurs within the electric fuse housing, wherein the one or more elements cool heat caused by the electric arc.

7. The electric fuse housing of claim 6, wherein the one or more elements comprise hydrogen, nitrogen, or oxygen.

8. The electric fuse housing of claim 1, wherein the one or more substances are applied as conformal coating.

9. The electric fuse housing of claim 8, wherein applying conformal coating comprises:
creating a liquid solution comprising the one or more substances; and
pouring the liquid solution into the plurality of pores.

10. The electric fuse housing of claim 9, wherein applying conformal coating further comprising applying one or more techniques to reduce surface tension, wherein the one or more techniques comprise ultrasonic, vacuum pressurization, oscillation, or heating.

11. The electric fuse housing of claim 9, wherein carrier of the liquid solution comprises solvent or alcohol.

12. The electric fuse housing of claim 1, wherein the barrier layer and the oxide layer are formed on both sides of the metal layer, wherein the plurality of pores on a first oxide layer on a first side of the metal layer are filled by one or more first substances, wherein the plurality of pores on a second oxide layer on a second side of the metal layer are filled by one or more second substances, and wherein the one or more first substances are different than the one or more second substances.

13. The electric fuse housing of claim 1, wherein the one or more electrical insulating plates are assembled with the anodized metal can structure to make the electrical fuse housing sealed.

14. The electric fuse housing of claim 13, wherein a portion of the anodized metal can structure is secured to the one or more electrical insulating plates by a way of crimping the portion of the anodized metal can structure or by applying adhesive between the one or more electrical insulating plates and the portion of anodized metal can structure.

15. The electric fuse housing of claim 13, wherein the one or more electrical insulating plates are made of polymer, ceramic, or anodized metal.

16. The electric fuse housing of claim 1, wherein the metal layer is comprised of aluminum.

17. The electric fuse housing of claim 1, wherein the electric fuse housing is configured as a radial fuse.

18. The electric fuse housing of claim 1, wherein the electric fuse housing is configured as an axial fuse.

19. The electric fuse housing of claim 1, wherein the electric fuse housing is configured as a cylindrical radial fuse.

20. A method for manufacturing an electric fuse housing, the method comprising:
creating, using a hard anodizing process, a barrier layer and an oxide layer on top of a metal layer of an anodized metal can structure, wherein the oxide layer comprises a plurality of pores;
filling the plurality of pores with one or more substances; and
assembling the anodized metal can structure with one or more electrical insulating plates.
